(19) United States
(12) Patent Application Publication
(10) Pub. No.: US 2026/0176152 A1
(43) Pub. Date: Jun. 25, 2026

(54) METHOD FOR PRODUCING CALCIUM CARBONATE

(71) Applicant: Kabushiki Kaisha Kobe Seiko Sho (Kobe Steel, Ltd.), Kobe-shi (JP)

(72) Inventors: Tatsuya SASAKI, Kobe-shi (JP); Katsuyuki IIJIMA, Takasago-shi (JP); Kazuki MURAKAMI, Takasago-shi (JP); Ryuichi KOBORI, Takasago-shi (JP); Koji SAKAI, Takasago-shi (JP); Shigeru KINOSHITA, Takasago-shi (JP); Yusuke TAKAHASHI, Kobe-shi (JP)

(73) Assignee: Kabushiki Kaisha Kobe Seiko Sho (Kobe Steel, Ltd.), Kobe-shi (JP)

(21) Appl. No.: 19/112,438

(22) PCT Filed: Aug. 21, 2023
(86) PCT No.: PCT/JP2023/030036

§ 371 Date: Mar. 17, 2025

(30) Foreign Application Priority Data
Oct. 6, 2022 (JP) 2022-161697

(51) Int. Cl. C01F 11/18; D21H 17/67; D21H 19/38

(52) U.S. Cl. CPC C01F 11/185; D21H 17/67; D21H 17/675; D21H 19/385; C01P 2004/03; C01P 2004/51; C01P 2004/61

(57) ABSTRACT

A method for producing calcium carbonate. The method involves controlling pH to be less than or equal to 7 by introducing carbon dioxide into a solution or a slurry containing calcium and one or more elements selected from iron, manganese, silicon, aluminum, and magnesium. A precipitate in the solution or the slurry with the pH controlled is produced and removed. Calcium carbonate is then obtained by deaerating the solution or the slurry after the removing.

### TECHNICAL FIELD

The present invention relates to a method for producing calcium carbonate.

### BACKGROUND ART

In recent years, carbon dioxide has been considered to have a great impact on global warming. As an effective measure against the problem of global warming, a technology for generating calcium carbonate (CaCO₃) by fixing carbon dioxide to a calcium-containing solution or slurry has attracted attention. When the brightness of calcium carbonate obtained in such a manner is improved, the calcium carbonate can be used for wide applications. Therefore, a method for improving the brightness of calcium carbonate has been proposed (Japanese Unexamined Patent Application, Publication No. S51-47597).

### PRIOR ART DOCUMENT

### Patent Document

Patent Document 1: Japanese Unexamined Patent Application, Publication No. S51-47597

### SUMMARY OF THE INVENTION

### Problems to be Solved by the Invention

Even when the method of Patent Document 1 is used, if a coloring component such as iron or the like is present in calcium carbonate, the coloring component may develop a color after the brightening treatment and degrade the brightness. Furthermore, a chemical such as hydrosulfite or the like is used in the method of Patent Document 1, and thus, it is difficult to reduce the cost for brightening calcium carbonate.

In view of the foregoing circumstances, an object of the present invention is to provide a method for producing calcium carbonate which enables reducing coloring components in calcium carbonate and obtaining calcium carbonate having high brightness at low cost.

### Means for Solving the Problems

A method for producing calcium carbonate according to an aspect of the present invention for solving the foregoing problems includes: controlling a pH to be less than or equal to 7 by introducing carbon dioxide into a solution or a slurry containing calcium and one or more elements selected from iron, manganese, silicon, aluminum, and magnesium; precipitating a precipitate in the solution or the slurry with the pH controlled; removing the precipitate from the solution or the slurry; and obtaining calcium carbonate by deaerating the solution or the slurry after the removing.

### Effects of the Invention

The method for producing calcium carbonate of the present invention enables reducing coloring components in calcium carbonate and obtaining calcium carbonate having high brightness at low cost.

### BRIEF DESCRIPTION OF THE DRAWINGS

FIG. 1 is a schematic view illustrating a production apparatus for producing calcium carbonate used in an embodiment of the present invention.

FIG. 2 is a graph showing the brightness of calcium carbonate obtained in Examples.

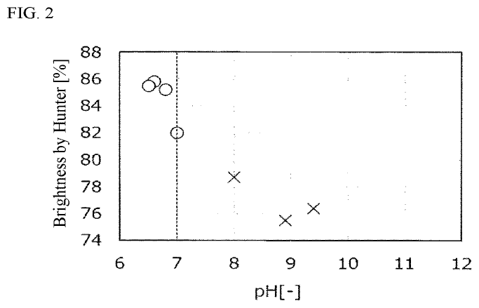

### DESCRIPTION OF EMBODIMENTS

A method for producing calcium carbonate according to an aspect of the present invention includes: controlling a pH to be less than or equal to 7 by introducing carbon dioxide into a solution or a slurry containing calcium and one or more elements selected from iron, manganese, silicon, aluminum, and magnesium; precipitating a precipitate in the solution or the slurry with the pH controlled; removing the precipitate from the solution or the slurry; and obtaining calcium carbonate by deaerating the solution or the slurry after the removing.

In the method for producing calcium carbonate (hereinafter, may be simply referred to as “the production method”), a reaction is caused by introducing carbon dioxide into the solution or the slurry containing calcium (Ca) and coloring component(s) such as iron and/or the like. This reaction allows calcium carbonate containing the coloring component(s) to be precipitated as a precipitate in the solution or the slurry. In the solution or the slurry from which the precipitate has been removed, a calcium component remains in a form of calcium hydrogen carbonate ions; therefore, by deaerating the solution or the slurry from which the precipitate has been removed, calcium carbonate containing reduced coloring components and having high brightness can be obtained. Furthermore, the production method does not require a chemical or the like and thus enables obtaining the calcium carbonate having high brightness at low cost.

The element(s) preferably includes/include at least one of iron or manganese. Iron and manganese are each likely to develop a color and are thus elements which should be particularly removed from the calcium carbonate. In the production method, iron and manganese are precipitated in the precipitate; therefore, the iron and the manganese remaining in the solution or the slurry from which the precipitate has been removed can be reduced.

The element(s) is/are preferably derived from iron and steel slag. That is to say, the calcium carbonate is preferably obtained from the solution or the slurry containing iron and steel slag. Thus, the calcium carbonate can be obtained at lower cost.

The solution or the slurry preferably contains water. Calcium is soluble in water; therefore, when the solution or the slurry contains water, the efficiency of obtaining the calcium carbonate can be improved.

The solution or the slurry preferably further contains a polyol compound. Calcium is soluble in a polyol compound; therefore, when the solution or the slurry further contains a polyol compound, the efficiency of obtaining the calcium carbonate can be further improved.

The polyol compound is preferably a diol compound or a triol compound. Thus, the efficiency of obtaining the calcium carbonate can be still further improved.

The polyol compound is preferably one or two or more diol compounds selected from the group consisting of ethylene glycol, propylene glycol, and diethylene glycol. Thus, the efficiency of obtaining the calcium carbonate can be even further improved.

The polyol compound is preferably glycerin. Thus, the efficiency of obtaining the calcium carbonate can be even still further improved.

As referred to herein, the “polyol compound” means an organic compound having a plurality of alcoholic hydroxyl groups (groups each obtained by substituting a hydrogen atom of an aliphatic hydrocarbon with a hydroxy group (—OH)). Similarly, the “diol compound” means an organic compound having two alcoholic hydroxyl groups, and the “triol compound” means an organic compound having three alcoholic hydroxyl groups.

### Details of Embodiments

Hereinafter, the present invention will be described in detail with reference to the drawings as appropriate. It is to be noted that the drawings are merely illustrative and schematically illustrate each component (each member); therefore, the shape, dimension, etc. thereof may be different in an actual case, and a member such as a pump for transferring a liquid (e.g., a solvent described later), a valve for appropriately controlling the timing of transferring the liquid, or the like may be omitted. Furthermore, the present specification may include a plurality of upper limit values and a plurality of lower limit values as numerical ranges of a component of the present invention. Such a plurality of upper limit values and such a plurality of lower limit values are presented as indicating that an arbitral value may be selected from one of the ranges of choices, or that an arbitral upper limit value may be combined with an arbitral lower limit value.

### Method for Producing Calcium Carbonate

The production method principally includes: a controlling step of controlling a pH to be less than or equal to 7 by introducing carbon dioxide into a solution or a slurry containing calcium and one or more elements selected from iron, manganese, silicon, aluminum, and magnesium; a precipitating step of precipitating a precipitate in the solution or the slurry with the pH controlled; a removing step of removing the precipitate from the solution or the slurry; and an obtaining step of obtaining calcium carbonate by deaerating the solution or the slurry after the removing step.

The one or more elements (hereinafter, referred to as “coloring component(s)”) selected from iron, manganese, silicon, aluminum, and magnesium is/are preferably derived from iron and steel slag. The iron and steel slag is a by-product which is inevitably generated in a process of producing iron and steel and contains coloring component(s) and calcium. Examples of the iron and steel slag include: steel slag generated in a process of producing steel, such as converter slag and electric furnace slag; blast furnace slag generated in a process of producing pig iron; and the like. In such iron and steel slag, for example, calcium is present in a form of calcium oxide (CaO).

The element(s) preferably includes/include at least one of iron or manganese. If iron and manganese, which are each likely to develop a color, remain in the calcium carbonate, the brightness thereof may deteriorate. For example, if the solution or the slurry contains trivalent iron ions (iron element), the iron element may cause a red deposit as Fe₂O₃ or Fe(OH)₃. Since the production method enables precipitating iron and manganese in the precipitating step described later, iron and manganese remaining in the solution or the slurry can be reduced, and the calcium carbonate having high brightness can be obtained.

The solution or the slurry preferably contains water. The water serves as a supply source of protons (H⁺) for ionization (into carbonate ions) of the carbon dioxide introduced into the solution or the slurry. Calcium dissolved in the solution or the slurry transfers to (diffuses in) the water as calcium ions, and the carbon dioxide introduced into the water is dissolved as carbonate ions (CO₃²⁻). As a result, the calcium ions and the carbonate ions react with each other in the water serving as a reaction field, to form calcium carbonate. Such water is not particularly limited as long as it functions as a catalyst as described above and may be, for example, pure water.

The solution or the slurry preferably further contains a polyol compound. Calcium is soluble in a polyol compound; therefore, when the solution or the slurry further contains a polyol compound, the efficiency of obtaining the calcium carbonate can be further improved.

The polyol compound is a medium for extracting calcium from the slag. The polyol compound is an organic compound having a plurality of alcoholic hydroxyl groups. An alcoholic hydroxyl group is a hydroxy group obtained by substituting a hydrogen atom of an aliphatic hydrocarbon and does not include a hydroxy group obtained by substituting a hydrogen atom of a hydrocarbon constituting an aromatic ring (for example, a hydroxy group of a phenol).

The polyol compound is not particularly limited as long as it is an organic compound having a plurality of alcoholic hydroxyl groups and is preferably a diol compound or a triol compound. Since being typically in a liquid state under normal pressure and temperature, the diol compound and the triol compound can be relatively easily mixed with the water.

The diol compound is not particularly limited as long as it is an organic compound having two alcoholic hydroxyl groups, and examples thereof include ethylene glycol, propylene glycol, diethylene glycol, butanediol, and diethanolamine. Of these, for example, the diol compound is preferably one or two or more selected from the group consisting of ethylene glycol, propylene glycol, and diethylene glycol.

For example, it is generally known that the solubility of calcium in ethylene glycol is approximately 10 times the solubility in water. In other words, the solubility of calcium in ethylene glycol is far higher than the solubility in water. Therefore, by using a diol compound such as ethylene glycol or the like, calcium can be more efficiently extracted from the iron and steel slag.

The triol compound is not particularly limited as long as it is an organic compound having three alcoholic hydroxyl groups, and glycerin is preferred. By using glycerin, calcium can be more efficiently extracted from the iron and steel slag.

In the case in which the solution or the slurry contains the water and the polyol compound, a ratio (P/W) of a mass (P) of the polyol compound to a mass (W) of the water is preferably greater than or equal to 0.2 and less than or equal to 0.93. The upper limit of the ratio (P/W) is more preferably 0.90 and still more preferably 0.89. When the ratio (P/W) is greater than the upper limit, the amount of the water may be insufficient with respect to that of the polyol compound, and it may be difficult to cause the reaction between the calcium ions and the carbonate ions in the controlling step described later. When the ratio (P/W) is less than the lower limit, the amount of the water may be excessive with respect to that of the polyol compound, and the efficiency of extracting calcium from the iron and steel slag may decrease.

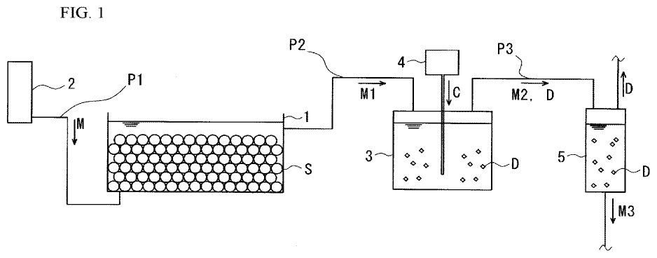

The production method is performed using, for example, a production apparatus for producing calcium carbonate as illustrated in FIG. 1. The production apparatus principally includes: a container 1 for forming a slag layer S by being charged with iron and steel slag; a supply portion 2 configured to supply the container 1 with a solution M; a retaining portion 3 configured to retain a calcium extract discharged from the container 1 after circulating through the slag layer S; an introduction portion 4 configured to introduce carbon dioxide C into an extract M1 retained in the retaining portion 3; and a separation portion 5 configured to subject, to solid-liquid separation, a precipitate D in a mixed solution M2 obtained by the introduction of the carbon dioxide by the introduction portion 4.

### Controlling Step

The controlling step includes: a circulating procedure in which the solution M is circulated through the slag layer S formed by charging the container with the iron and steel slag containing coloring component(s) and calcium; and an introducing procedure in which the carbon dioxide C is introduced into the solution (calcium extract M1) which has been circulated through the slag layer S.

In the circulating procedure, the solution M supplied by the supply portion 2 is circulated through the slag layer S formed in the container 1, whereby the coloring component(s) and the calcium in the iron and steel slag forming the slag layer S are extracted into the solution M. The calcium is extracted as calcium ions (Ca²⁺). The supply portion 2 supplies the container 1 with the solution M through a solvent supply pipe P1 which connects the container 1 to the supply portion 2. The solution M into which the coloring component(s) and the calcium have been extracted is supplied as the calcium extract M1 to the retaining portion 3 through an extract supply pipe P2. The iron and steel slag from which the coloring component(s) and the calcium have been extracted can be removed from the container 1 and then dried to be used as resources such as a base course material (road material), a fertilizer, and the like.

In the introducing procedure, the introduction portion 4 introduces the carbon dioxide C into the calcium extract M1 retained in the retaining portion 3. The introduction portion 4 is not particularly limited and may be, for example, a known gas blowing apparatus. The introduction of the carbon dioxide C by the introduction portion 4 is preferably performed while agitating the calcium extract M1 in the retaining portion 3.

The introduction portion 4 introduces the carbon dioxide C such that a pH of the calcium extract M1 is less than or equal to 7. The upper limit value of the pH of the calcium extract M1 is preferably less than 7 and more preferably less than 6.9. The lower limit value of the pH of the calcium extract M1 is not particularly limited and may be, for example, greater than or equal to 4.0. By setting the pH of the calcium extract M1 to be less than or equal to the upper limit value, the brightness of calcium carbonate to be obtained is improved.

A gas introduced from the introduction portion 4 may be a gas consisting of carbon dioxide, may be the atmosphere (air) containing carbon dioxide, or may be a carbon dioxide-containing exhaust gas or the like discharged in industrial activities such as factory or plant operation, transportation, etc.

### Precipitating Step

By introducing the carbon dioxide into the calcium extract M1, the carbon dioxide C is dissolved as carbonate ions in the calcium extract M1. When the calcium ions and the carbonate ions react with each other, calcium carbonate is precipitated as the precipitate D. In the production method, the calcium extract M1 into which the carbon dioxide C is introduced is controlled to have a pH of less than or equal to 7; therefore, more coloring components in the calcium extract M1 can be incorporated into the precipitate D.

Together with the precipitate D, the calcium extract M1 having the pH value controlled by the introduction of the carbon dioxide C is supplied as the mixed solution M2 to the separation portion 5 through a mixed solution supply pipe P3.

### Removing Step

The mixed solution M2 supplied from the retaining portion 3 to the separation portion 5 is subjected to solid-liquid separation. That is to say, the separation portion 5 performs separation into the precipitate D and the mixed solution M2 from which the precipitate D has been removed (separate liquid M3). The separation portion 5 is not particularly limited and may be, for example, a known centrifuge. The precipitate D separated can be used, for example, as resources such as a filler for resin and the like.

### Obtaining Step

Calcium ions remain in the separate liquid M3 from which the precipitate D has been removed in the separation portion 5. By deaerating the separate liquid M3, more calcium carbonate can be obtained. Since the coloring component(s) in the iron and steel slag has/have been precipitated in the precipitate D, the amount of the coloring component(s) remaining in the separate liquid M3 is reduced. Therefore, the calcium carbonate obtained by deaerating the separate liquid M3 has high brightness. Such calcium carbonate having high brightness is suitably used as part of raw materials of highly bright products such as resins, paper, concrete, and the like.

A deaeration method is not particularly limited as long as the carbon dioxide in the separate liquid M3 can be removed, and a known method such as air curing deaeration, heat boiling deaeration, ultrasonic deaeration, deaeration under vacuum and reduced pressure, centrifugal deaeration, gas injection deaeration, or the like may be employed. An injection gas in the case of the gas injection deaeration is preferably an insoluble gas such as nitrogen, argon, or the like.

### Advantages

In the production method, the precipitate is precipitated by introducing the carbon dioxide into the solution into which the coloring component(s) and the calcium have been extracted from the iron and steel slag, while controlling the pH of the solution; therefore, the coloring component(s) is/are precipitated in the precipitate, and the amount of the coloring component(s) remaining in the solution from which the precipitate has been removed is reduced. Therefore, according to the production method, the brightness of calcium carbonate obtained by deaerating the solution from which the precipitate has been removed can be improved. Furthermore, since the production method uses the iron and steel slag, which is a by-product, and does not use a chemical or the like for improving the brightness of the calcium carbonate, the calcium carbonate having high brightness can be produced at low cost.

### Other Embodiments

The above embodiments do not limit the configuration of the present invention. Therefore, in the above embodiments, the components of each part of the above embodiments can be omitted, replaced, or added based on the description in the present specification and general technical knowledge, and such omission, replacement, or addition should be construed as falling within the scope of the present invention.

The coloring component(s) and the calcium do not necessarily need to be extracted into the solution but may be extracted into a slurry.

A material containing the coloring component(s) and the calcium is not limited to the iron and steel slag and may be, for example, cement, concrete waste, glass waste, coal ash, sludge incineration ash, woody biomass ash, or the like.

The solution or the slurry may contain other solvent(s), additive(s), and/or the like besides the polyol compound and the water within a range not leading to inhibition of the calcium extraction efficiency. Examples of the other solvent(s), additive(s), and/or the like include a hydrophilic solution and the like. Examples of the hydrophilic solution include ethanol, methanol, and the like. Furthermore, in the circulating step, a mixed solution of the polyol compound and an aqueous solution in which an additive other than the solvent is dissolved in water may be used.

### Examples

Hereinafter, the present invention is further described by way of Examples; the present invention is not limited to the Examples.

As a first test, a comparison test between the brightness of a precipitate and that of calcium carbonate was conducted. As substances each containing coloring components and calcium, two types of steel slag were prepared. The coloring components contained in the two types of steel slag are shown in Table 1. The two types of steel slag were crushed using a jaw crusher, and materials having a grain size of less than 4.75 mm were used.

TABLE 1

| | T-Fe | SiO₂ | CaO | Al₂O₃ | MnO | MgO |
|---|---|---|---|---|---|---|
| Steel slag 1 | 22.4 | 11.3 | 44.4 | 1.5 | 2.8 | 5.3 |
| Steel slag 2 | 19.7 | 12.0 | 46.2 | 1.5 | 2.6 | 7.6 |

As a solution into which calcium was to be extracted from the steel slag, glycerin (produced by FUJIFILM Wako Pure Chemical Corporation; purity: greater than 99.5%) and pure water were prepared.

In a container prepared, 400 g of the glycerin and 600 g of the pure water were mixed to obtain a solution. A nitrogen gas was injected into the solution at 0.5 L/min for 10 min, and 100 g of the steel slag 1 was then charged into the resulting solution. After that, while a nitrogen gas was circulated through a gas phase portion in the container at 0.5 L/min, the solution was agitated using an agitator at 300 rpm for 90 min to extract calcium. After the extraction, the solution was subjected to centrifugation at 3,000 rpm for 5 min and was then filtered through filter paper (No. 5A) to obtain a calcium extract.

Table 2 shows the results of analyzing components of the calcium extract. It can be seen that the calcium extract contains, besides calcium, iron and manganese, which are coloring components. It is to be noted that the analysis was conducted using an ICP emission spectrometer.

TABLE 2
Analytical results of calcium extract

| Ca (mg/L) | Fe (mg/L) | Mn (mg/L) |
|---|---|---|
| 3,200 | 67.6 | 31.5 |

Other five containers and five calcium extracts obtained by the above-described method were prepared. Into each container, 900 g of the calcium extract was injected, and a pH meter (manufactured by Hanna Instruments Japan, benchtop type, pH/EC HI-5522) was inserted.

Carbon dioxide was introduced into the calcium extract in each container at 0.5 L/min, while controlling the pH thereof. At a point of time when the pH reached a predetermined value, the calcium extract was filtered through filter paper (No. 5C) to be separated into a precipitate and a separate liquid. The precipitate was subjected to washing treatment using 100 g of pure water and then to vacuum drying treatment under conditions including 10 mmHg and 105° C. for 3 hrs or longer. Each of the separate liquids was further injected into another container and deaerated by air curing at room temperature for 48 hrs or longer. After the deaeration, filter paper (No. 5C) was used to obtain calcium carbonate. The calcium carbonate was subjected to washing treatment using 100 g of pure water and then to vacuum drying treatment under conditions including 10 mmHg and 105° C. for 3 hrs or longer. Values of the pH of each calcium extract, the brightness of each precipitate, and the brightness of each calcium carbonate are shown in Table 3. As the brightness, the brightness by Hunter of each sample was evaluated using a spectrophotometric colorimeter (manufactured by Konica Minolta, Inc., CM-600d).

TABLE 3

Brightness by Hunter

| | pH | precipitate | calcium carbonate |
|---|---|---|---|
| Test Example 1 | 9.4 | 80.6 | 76.4 |
| Test Example 2 | 8.9 | 80.2 | 75.5 |
| Test Example 3 | 8.0 | 81.6 | 78.7 |
| Test Example 4 | 7.0 | 80.2 | 82.0 |
| Test Example 5 | 6.8 | 75.3 | 85.2 |

In each of Test Examples 1 to 3, in which the pH was greater than 7, the brightness by Hunter of the calcium carbonate was lower than the brightness by Hunter of the precipitate. On the other hand, in each of Test Examples 4 and 5, in which the pH was less than or equal to 7, the brightness by Hunter of the calcium carbonate was higher than the brightness by Hunter of the precipitate. Furthermore, the brightness by Hunter of the calcium carbonate of each of Test Examples 4 and 5 was higher than the brightness by Hunter of each of Test Examples 1 to 3. These results indicate that by introducing carbon dioxide such that the pH of the calcium extract is less than or equal to 7, calcium carbonate having high brightness can be obtained.

As a second test, a comparison test of the brightness of calcium carbonate in terms of the amount of coloring components contained in the steel slag was conducted. Two containers were prepared, and 120 g of glycerin and 280 g of pure water were mixed in each container to obtain a solution. After a nitrogen gas was injected into each solution at 0.5 L/min for 10 min, 40 g of the steel slag I was charged into one of the containers, and 40 g of the steel slag 2 was charged into the other container. After that, while a nitrogen gas was circulated through a gas phase portion in each container at 0.5 L/min, the solution was agitated using an agitator at 300 rpm for 90 min to extract calcium. After the extraction, the solution was subjected to centrifugation at 3,000 rpm for 5 min and was then filtered through filter paper (No. 5A) to obtain a calcium extract.

Into other two containers, 300 g of the respective calcium extracts were injected, and pH meters were inserted. Carbon dioxide was introduced into the calcium extract in each container at 0.5 L/min, while controlling the pH thereof. At a point of time when the pH reached a predetermined value, the calcium extract was filtered through filter paper (No. 5C) to be separated into a precipitate and a separate liquid. The precipitate was subjected to washing treatment using 100 g of pure water and then to vacuum drying treatment under conditions including 10 mmHg and 105° C. for 3 hrs or longer. Each of the separate liquids was further injected into another container and deaerated by air curing at room temperature for 48 hrs or longer. After the deaeration, filter paper (No. 5C) was used to obtain calcium carbonate. The calcium carbonate was subjected to washing treatment using 100 g of pure water and then to vacuum drying treatment under conditions including 10 mmHg and 105° C. for 3 hrs or longer. Values of the pH of each calcium extract, the brightness of each precipitate, and the brightness of each calcium carbonate are shown in Table 4.

TABLE 4

| | | | Brightness by Hunter | |
|---|---|---|---|---|
| | Steel slag | pH | precipitate | calcium carbonate |
| Test Example 6 | steel slag 1 | 6.6 | 78.3 | 85.8 |
| Test Example 7 | steel slag 2 | 6.5 | 83.9 | 85.5 |

When Test Examples 6 and 7 are compared with each other, the difference in the brightness by Hunter of the precipitate is relatively large, while the difference in the brightness by Hunter of the calcium carbonate is very small. Furthermore, in both test examples, the brightness by Hunter of the calcium carbonate is higher than the brightness by Hunter of the precipitate. These results indicate that by introducing carbon dioxide such that the pH of the calcium extract is less than or equal to 7, calcium carbonate having high brightness can be stably obtained regardless of the amount of coloring components contained in the steel slag.

### INDUSTRIAL APPLICABILITY

According to the present invention, calcium carbonate having high brightness can be obtained at low cost by effectively utilizing carbon dioxide as a resource, and thus, calcium carbonate of high value can be provided.

### EXPLANATION OF THE REFERENCE SYMBOLS

1: Container
2: Supply portion
3: Retaining portion
4: Introduction portion
5: Separation portion
C: Carbon dioxide
D: Precipitate
M: Solution
M1: Calcium extract
M2: Mixed solution
M3: Separate liquid
P1: Solvent supply pipe
P2: Extract supply pipe
P3: Mixed solution supply pipe
S: Slag layer

1. A method for producing calcium carbonate, the method comprising:
controlling a pH to be less than or equal to 7 by introducing carbon dioxide into a solution or a slurry comprising calcium and one or more elements selected from the group consisting of iron, manganese, silicon, aluminum, and magnesium;
precipitating a precipitate in the solution or the slurry with the pH controlled;
removing the precipitate from the solution or the slurry; and
obtaining calcium carbonate by deaerating the solution or the slurry after the removing.

2. The method according to claim 1, wherein the one or more elements comprise at least one selected from the group consisting of iron and manganese.

3. The method according to claim 1, wherein the one or more elements are derived from iron and steel slag.

4. The method according to claim 1, wherein the solution or the slurry further comprises water.

5. The method according to claim 4, wherein the solution or the slurry further comprises a polyol compound.

6. The method according to claim 5, wherein the polyol compound comprises a diol compound or a triol compound.

7. The method according to claim 5, wherein the polyol compound comprises one or more diol compounds selected from the group consisting of ethylene glycol, propylene glycol, and diethylene glycol.

8. The method according to claim 5, wherein the polyol compound comprises glycerin.

9. The method according to claim 2, wherein the one or more elements are derived from iron and steel slag.

10. The method according to claim 2, wherein the solution or the slurry further comprises water.
